(19) United States
(12) Patent Application Publication
(10) Pub. No.: US 2003/0169426 A1
(43) Pub. Date: Sep. 11, 2003

(54) Test member orientation

(76) Inventors: Timothy A. Peterson, Victoria, MN (US); Andrew K. Suter, Bury St. Edmunds (GB)

Correspondence Address: O'KEEFE, EGAN & PETERMAN, L.L.P., Building C, Suite 200, 1101 Capital of Texas Highway South, Austin, TX, 78746, US

(21) Appl. No.: 10/094,501

(22) Filed: Mar. 8, 2002

(51) Int. Cl. G01N 21/47

(52) U.S. Cl. 356/446

(57) ABSTRACT

The present invention relates to a test meter (1) capable of determining the orientation of a test member (2) within it. The test member (2) has a first major surface (22) and an opposing second major surface (24). Each major surface includes an orientation indicator region, the orientation indicator regions differing by at least one optical property, for example reflectance. The test meter (2) has a test region (30) for accepting a test member (2). The test region (30) comprising an optical orientation sensor (34) aligned with the orientation indicator region of one major surface of a test member (2) within the test meter (1). The optical orientation sensor (34) generating an orientation signal indicative of an optical property of the orientation indicator region. The test meter also has a processor (36) for receiving the orientation signal and determining the orientation of the test member (2).

### BACKGROUND

a. Field of the Invention

The present invention relates to a test meter and method of determining the orientation of a test member within said test meter, particularly a test meter for testing analyte levels in bodily fluid samples.

b. Related Art

Providing clinical products for the home test market, for instance a blood glucose meter (BGM), has several problems associated with it. It is important that the patient uses the product in the correct manner to achieve an accurate result. Complete instructions for use are usually supplied with any such product, but there is no guarantee that a user will read such instructions. It is therefore important that the operation of such a clinical product is as simple and intuitive as possible and that, wherever possible, any error is indicated to the user.

In order for a diabetic patient to measure accurately their blood glucose concentration they typically use a BGM and a disposable test strip. The test strip will usually include an enzyme specific for β-D-glucose so that when a whole blood sample is added to the strip a reaction will occur. The reaction progress may be monitored using a chromagen included on the test strip to change colour as the reaction proceeds. The colour change can then be measured by the BGM using the reflectance of the strip. Usually the blood is added to one side of the strip and the progress of the reaction measured by observing the other side. To use some BGMs, the whole blood sample is placed on the strip and the strip is then inserted into the BGM to obtain a reading. It is important that the strip is not inserted into the BGM upside-down, as this will provide the user with an anomalous reading.

It is known to include graphics, or other visible indicators on the test strips so that user can determine which way up the strips should be inserted. Test strips may also be provided with an asymmetrical shape so that the test strip can only be fully inserted into the meter in the correct orientation. These methods do not prevent the BGM providing a reading with the test strip incorrectly oriented or not fully inserted.

It is known from patent document WO9607907 to provide a test meter capable of determining the orientation of a test strip being inserted into the test meter. The test strip includes an orientation index zone on one surface having a contrasting reflectance relative to the areas of the surface contiguous with the index zone. As the test strip is inserted into the test meter, the test sensor sequentially reads the index zone, then the contiguous surface. The test member then reports the presence or absence of the index zone. When the test strip is correctly inserted into the test meter, the test sensor is aligned with a test region of the test strip. Such a system does not prevent the BGM providing a test reading with the test strip partially inserted, or moved/removed during the testing.

### SUMMARY OF THE INVENTION

It is an object of the present invention to address some of the problems cited above.

Accordingly, the invention provides a test apparatus, comprising a test member and a test meter capable of determining the orientation of a stationary test member therein, the test member comprising a first major surface and an opposing second major surface, each major surface having an orientation indicator region, the orientation indicator regions differing by at least one optical property, the test meter having a test region for accepting a test member, the test region being provided with an optical orientation sensor for measuring the at least one optical property of an orientation indicator region of a test member within the test meter, the optical orientation sensor generating an orientation signal indicative of the at least one optical property of the orientation indicator region, the test meter further comprising a processor for receiving said orientation signal and determining the orientation of the test member.

By determining the orientation of the test member using the test meter, user errors can be detected by the meter and indicated to the user. The user can then correct the error and a test can be correctly performed. By performing the orientation determination when the test member is stationary within the test meter rather than as it is inserted, it is possible to ensure that the test member remains in substantially the correct orientation or position during the test. The orientation sensor can continue to measure an optical property of a portion of the test member during the test and the processor can detect any changes that may indicate that the test member has moved. The optical property by which the two orientation regions differ is preferably reflectivity, but may be any other measurable optical property. Such a difference may be achieved using different colours, textures, additional materials or other methods.

In one embodiment, the orientation indicator region of only one major surface of the test member has an optical property differing from the substrate from which the test member is formed. This facilitates manufacture of the test members, as an optical property of only one region of one surface of each test member must be altered. The alteration of the region is preferably by the addition of a coloured and/or textured layer in the orientation indicator region. Such an additional layer may serve as a visual orientation indicator and cover a region larger than the orientation indicator region. With such an embodiment of a test member, the orientation signal from the orientation sensor when a test member is within the test meter will be indicative of the coloured and/or textured layer or of the substrate. Thus the meter can only detect the orientation of a fully inserted test member by the presence or lack of the coloured and/or textured layer. Partial insertion or movement of the member during a test cannot necessarily be detected.

In a second embodiment, the orientation indicator region of each major surface of the test member may differ from the contiguous surface surrounding it by an optical property, but this is not essential provided the two orientation indicator regions differ from one another by an optical property. If the orientation indicator regions do differ by an optical property from the contiguous surface surrounding them it may allow the processor to determine more detailed information relating to orientation and correct insertion of the test member from the orientation signal. This is especially true if the orientation indicator regions are substantially no bigger than the region detected by the orientation sensor.

Any error detected by the processor can be indicated to the user by a visual display, such as an LCD and/or by means of an alarm which may be audible and/or visible, such as a buzzer or flashing light.

Preferably, the test member is an elongate test strip comprising a test portion that is visible from both sides of the test strip, for instance located on one side, but visible from the other side through an aperture in the test strip. The test portion preferably changes colour depending upon a characteristic of an applied liquid sample. On the first major surface of the test strip there is preferably a visual orientation marker in the orientation indicator region to aid a user in determining the correct orientation of the test strip. The orientation indicator region may surround the test portion and may indicate to the user the region to which the liquid sample to be tested should be applied. There may be a mesh, either woven or non-woven, covering some or all of the visual orientation marker and the test portion to help spread a liquid sample evenly over the test portion. The second major surface preferably has an orientation indicator region that has a different reflectivity to that of the orientation indicator region of the first major surface.

Preferably the test meter includes an optical test sensor in the test region. The test sensor is for measuring an optical property, for instance reflectance, of the test portion of a test strip when the test strip is correctly inserted into the test meter. The test sensor and orientation sensor may measure the optical properties of regions of the same major surface and may be located adjacent one another in the test meter. Preferably, the orientation sensor is spaced from the test sensor in a direction either perpendicular or parallel with the direction of insertion of a test member. As this facilitates manufacture and design of the test members and test meter.

The optical sensors detect radiation reflected from a target. Each sensor may also emit radiation towards its target. Each sensor may be a combined unit that both emits radiation and detects the reflected radiation, or may comprise two units, one that emits the radiation and one that detects reflected radiation. The sensors are preferable static within the test meter and are aligned with the desired target regions of the test strip when a test strip is correctly inserted into the meter. The desired target regions of the test strip being, for the test sensor, the test portion and for the orientation sensor, the orientation indicator region. Although any light emitter and detector may be used, it is currently preferred that at least the orientation sensor uses radiation with a wavelength of between about 400-950 nm, preferably with a wavelength of about 950 nm.

The orientation indicator region of the second embodiment of the test member is preferably only the target region of the orientation sensor when the test member is fully inserted into the test meter. An optical property of the orientation indicator regions of the test member differs from the contiguous surface surrounding the orientation indicator regions. The processor can therefore determine from the orientation signal whether the orientation signal is indicative of one or other of the orientation indicator regions, and hence determine that the strip is fully inserted and the orientation of the test strip. The processor can also determine whether the orientation signal is not indicative of one of the orientation indicator regions and hence determine that the test member is not fully inserted, or an incorrect or faulty test member is being used.

If the meter includes a data download sensor in addition to a test sensor, the data download sensor may be used as the orientation sensor.

The invention will be described hereinafter with reference to a preferred embodiment of a test meter with a test sensor and orientation member positioned in the test region to read the second surface of a correctly inserted test member. The invention will also be described with reference to a preferred embodiment of a test member with a visual orientation marker in the orientation indicator region of the first surface. It should be understood that the invention is not so limited.

To test a liquid sample, the sample is applied to a test portion on the first side, indicated by the visual orientation marker, of the test strip in a known manner. The test strip is then inserted into the test meter. When the strip has been inserted, a test is started. The orientation sensor produces an orientation signal indicative of the reflectance of a portion of the test strip.

The processor receives the signal and determines whether or not the orientation signal is indicative of a test strip that has been inserted correctly. This can be done in several ways.

The processor can determine whether the orientation signal is indicative of the reflectance of the orientation indication region of the second surface. If it is, the processor may determine that the test strip is correctly inserted. If not, the processor may determine that the strip is not correctly inserted.

The processor can determine whether the orientation signal is indicative of the reflectance of the orientation indication region of the first surface. If it is, the processor may determine that the test strip is inserted upside-down. If not, the processor may determine that the strip is correctly inserted.

Another option is that the processor can determine whether the orientation signal is indicative of the reflectance of the orientation indication region of the first surface or second surface and provide the appropriate response if the orientation signal corresponds to one or the other. If the orientation signal corresponds to neither, the processor can determine that the strip is not fully inserted, that there is a fault with the strip or that the wrong test strip is being used. The processor may then indicate this using a display or alarm.

The processor also receives a test signal from the test sensor. If the processor determines that the test strip is correctly inserted the test signal is processed to determine the reflectance of the test portion and hence a characteristic of the liquid sample applied to the test portion.

The testing phase of the process, during which the test sensor measures the reflectance of the test portion, may take a few seconds or longer and it is desirable that the test strip is not removed or moved during testing or a false reading may be made.

To allow the processor to detect movement of the test strip, the processor may monitor the orientation signal from the orientation sensor and any change in the signal can be processed to determine whether the change is indicative of the test strip being moved. If the change is indicative of test strip movement, the processor can report to the user that an error has occurred and indicate that the test must be repeated.

### BRIEF DESCRIPTION OF THE DRAWINGS

The invention will now be further described, by way of example, with reference to the accompanying drawings, in which:

FIG. 1 is a view of a test meter and test member according to a preferred embodiment of the invention;

FIG. 2 is an exploded view of a test member suitable for use with the present invention;

FIG. 3 is a schematic cross-section view of the internal arrangement of a test meter according to the present invention with a test strip correctly inserted into the test meter;

FIGS. 4, 5 and 6 are schematic cross-section views of the internal arrangement of a test meter according to the present invention with, respectively, a test strip correctly inserted, a test strip inserted into the test meter upside down and a test strip partially inserted into the test meter.

### DETAILED DESCRIPTION

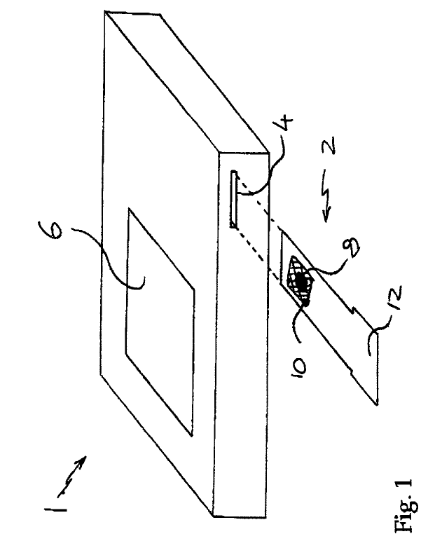

FIG. 1 shows test meter 1 according to the present invention and a test member 2 suitable for use with the present invention, in this case a test strip. The test meter 1 includes a slot 4 into which the test strip 2 can be inserted in order to perform a test. The test meter 1 also includes a display screen 6 for displaying the result of the test or other information.

The test strip 2 has a test portion 8 onto which a liquid sample, for example whole blood should be placed. An optical property of the test portion 8 changes depending upon a characteristic of the liquid sample, for instance the colour of the test portion 8 may change depending upon the glucose level in a sample of whole blood.

The test strip 2 also includes a visual orientation marker 10, which surrounds the test portion 8 on one side of the test strip 2. The visual orientation marker 10 indicates to the user the region where the liquid sample should be placed. The visual orientation marker 10 also serves to indicate to a user which way up the test strip 2 should be inserted into the test meter 1. The test strip includes an enlarged end 12 so that the test strip 2 cannot be inserted back to front into the test meter 1.

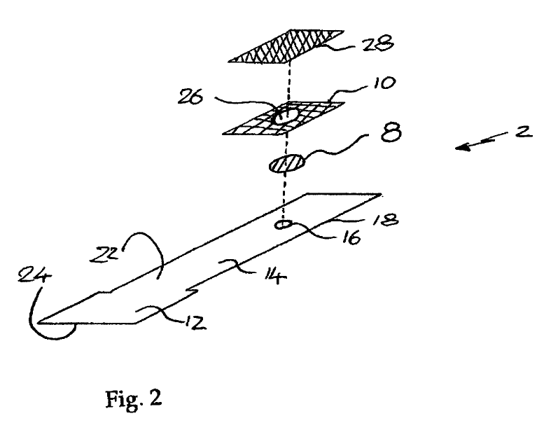

FIG. 2 shows an exploded view of a test strip 2 suitable for use with the present invention. The strip comprises an elongate Mylar™ substrate 14 with an enlarged end 12 and an aperture 16 in an opposing end portion 18. The Mylar™ substrate is coloured white or off-white. The substrate 14 has two major surfaces 22,24. A test portion 8 is attached to a first major surface 22 such that it covers the aperture 16. A visual orientation marker 10, including an aperture 26 is then attached over the test portion such that the aperture 26 is aligned with the test portion 8. A mesh 28 is then attached over the visual orientation marker 10. The mesh 28 is, in this case, a woven nylon or polypropylene material.

When assembled, the first surface 22 of the test member 2 may be used for accepting a liquid sample to be tested. The mesh 28 distributes the liquid evenly by wicking the liquid over the surface of the test portion 8. The marker 10 defines an orientation indicator region of the surface 22. The second surface 24 also has an orientation indicator region in a corresponding location. The second surface 24 of the test strip 2 has an aperture 16 though which the test portion 8 is visible. The orientation indicator region of the second surface 24 has different optical properties to those of the orientation indicator region of the first surface 22.

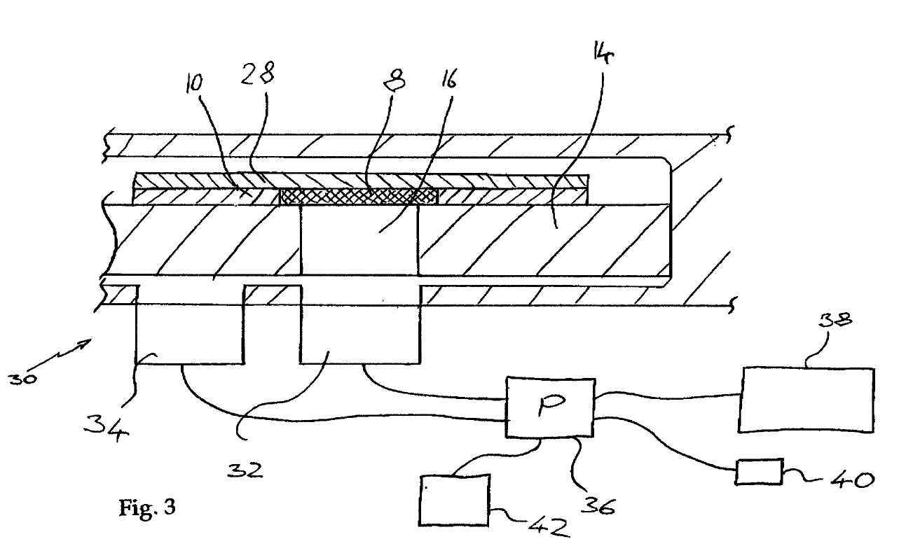

FIG. 3 shows schematic view of a cross section through a test region of a test meter 1 with a strip correctly inserted into the test meter 1. The test region 30 of the test meter 1 includes an optical test sensor 32. The optical test sensor 32 is aligned with the test portion 8 of a correctly inserted test strip 2 such that measurement of an optical property of the test portion 8 can be made when a test strip 2 is correctly inserted into the test meter 1. The test region 30 also includes an optical orientation sensor 34 aligned with at least part of the orientation indicator region of the test strip 2.

When a test is to be performed, the optical sensors 32,34 emit light towards a target and detect the light reflected from said target. The sensors then generate a signal indicative of the reflectivity of the target. In FIG. 3 the target of the optical test sensor 32 is the test portion 8, so a signal indicative of the colour of the test portion 8 will be generated. In FIG. 3, the target of the optical orientation sensor 34 is the orientation indicator region of the test strip 2. In this case, the test strip 2 has been correctly inserted so the orientation sensor 34 is generating a signal indicative of the reflectance of the orientation indicator region of the second major surface 24. In this case the orientation sensor produces a signal indicative of the reflectance of the substrate 14.

The signals from the sensors 32,34 are received by a processor (P) 36. The processor 36 processes the signal from the orientation sensor 34 to determine the orientation of the test strip 2 within the test meter 2 by testing the signal from the orientation sensor 34. A correct orientation signal from the orientation sensor is a signal indicative of the reflectance of the substrate 14. Any other signal from the orientation sensor is an incorrect orientation signal.

If the orientation is incorrect, the processor 36 sends an incorrect orientation signal to a display 38, in this case an LCD, to provide a visual indication that the test strip 2 is not correctly inserted. The processor 36 may also send a signal to an alarm 40 to generate an audible/visual warning.

If the orientation is correct, the processor 36 processes the signal from the test sensor 32 to determine the reflectance of the test portion 8 and hence the characteristic of the fluid applied to the test strip 2. The processor 36 then displays the characteristic of the fluid sample on the display 38.

The processor 36, sensors 32,34, display 38 and alarm 40 all receive electrical power from a power source 42 within the test meter 1.

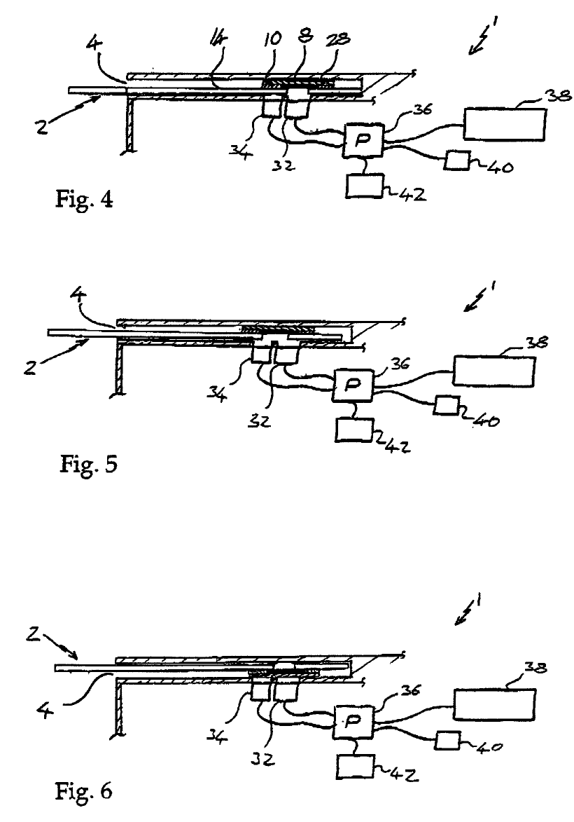

FIG. 4 shows a schematic view of a cross section through a test meter 1 with a test strip 2 correctly inserted into the test meter 1. The orientation sensor 34 produces a signal indicative of the reflectance of the substrate 14 indicating that the test strip 2 is correctly inserted. The test sensor 32 produces a signal indicative of the reflectance of the test portion 8 so an accurate test can be performed.

FIG. 5 shows a test strip 2 only partially inserted into the test meter 1. The orientation sensor 34 produces a signal not indicative of the reflectance of the substrate 14 because the substrate 14 no longer forms the entire target of the sensor 34. The processor 36 will detect that the signal from the orientation sensor 34 is an incorrect orientation signal and indicate the error with the display 38 and/or alarm 40. In this case, detection of such a partial insertion is possible because the orientation sensor 34 is located behind the test sensor 32 in the direction of insertion of the strip 2. The position of the orientation sensor 34 is not so limited, as the orientation sensor may be located anywhere within the test meter, for instance behind, in front of, or next to the test sensor in the direction of insertion of the test strip. A partial insertion may not be detectable by the processor if the orientation indicator region of the second surface 24 does not have a different optical property from the contiguous surface surrounding it.

FIG. 6 shows a test strip 2 fully inserted upside-down. The orientation sensor 34 now produces a signal indicative of the reflectance of the visual orientation marker 10 in the orientation index region of the surface 22 of the test strip 2. The processor 36 again detects that the signal from the orientation sensor 34 is an incorrect orientation signal and indicates the error with the display 38 and/or alarm 40.

The present invention has been described above purely by way of example. It should be noted that modifications in detail may be made within the scope of the invention as defined in the claims.

What is claimed is:

1. A test apparatus, comprising a test member and a test meter capable of determining the orientation of a stationary test member therein, the test member comprising a first major surface and an opposing second major surface, each major surface having an orientation indicator region, the orientation indicator regions differing by at least one optical property, the test meter having a test region for accepting a test member, the test region being provided with an optical orientation sensor for measuring the at least one optical property of an orientation indicator region of a test member within the test meter, the optical orientation sensor generating an orientation signal indicative of the at least one optical property of the orientation indicator region, the test meter further comprising a processor for receiving said orientation signal and determining the orientation of the test member.

2. Apparatus as claimed in claim 1, in which the test meter further comprises a display for indicating an incorrect insertion of the test member.

3. Apparatus as claimed in claim 1, in which the test meter further comprises an alarm for indicating an incorrect insertion of the test member.

4. Apparatus as claimed in claim 1, in which the processor determines that the orientation of the test strip is correct if the orientation signal is indicative of the reflectance of the orientation indicator region of the second major surface.

5. Apparatus as claimed in claim 1, in which the processor determines that the orientation of the test strip is not correct if the orientation signal is indicative of the reflectance of the orientation indicator region of the first major surface.

6. Apparatus as claimed in claim 1, in which the at least one optical property by which the orientation indicator regions differ is reflectance.

7. Apparatus as claimed in claim 1, in which the test member includes in the orientation indicator region of the second major surface a visual orientation marker.

8. Apparatus as claimed in claim 1, in which the test member includes a test portion for receiving a liquid sample to be tested, the colour of said test portion varying depending upon a characteristic of said liquid sample.

9. Apparatus as claimed in claim 8, in which the liquid is to be applied to the test portion on the second major surface of the test member and the test portion is visible through the first major surface.

10. Apparatus as claimed in claim 8, in which the test meter includes an optical test sensor for producing a signal indicative of the reflectance of the test portion.

11. Apparatus as claimed in claim 10, in which the test sensor and the orientation sensor both generate a signal indicative of the reflectance of regions of the same major surface of the test strip.

12. Apparatus as claimed in any of claims 8, in which the orientation indicator region of the test member is adjacent to the test portion.

13. Apparatus as claimed in any claim 12, in which the orientation indicator region substantially surrounds the test portion.

14. Apparatus as claimed in claim 1, in which the test member is an elongate test strip.

15. A method of determining the orientation of test member within a test meter, the test member comprising a first major surface and an opposing second major surface, each major surface comprising an orientation indicator region, the orientation indicator regions differing by at least one optical property, the test meter comprising a test region for accepting a test member and a processor, the test region comprising an optical orientation sensor aligned with the orientation indicator region of one major surface of a test member within the test meter, the method comprising the steps of:
a) using the orientation sensor to produce an orientation signal indicative of the reflectance of the orientation indicator region of one surface of the test member; and
b) using the processor to determine which of the orientation indicator regions is being measured by the orientation sensor.

16. A test meter for use in the method of claim 15, the test meter having a test region for accepting a test member, the test region being provided with an optical orientation sensor for measuring the at least one optical property of an orientation indicator region of a test member within the test meter, the optical orientation sensor generating an orientation signal indicative of the at least one optical property of the orientation indicator region, the test meter further comprising a processor for receiving said orientation signal and determining the orientation of the test member.

17. A test member adapted for use in the method of claim 15, the test member having the test member comprising a first major surface and an opposing second major surface, each major surface having an orientation indicator region, the orientation indicator regions differing by at least one optical property.

18. A test apparatus, comprising a test member and a test meter capable of determining the orientation of a stationary test member fully inserted therein, the test member comprising a first major surface and an opposing second major surface, each major surface having an orientation indicator region, the orientation indicator regions differing by at least one optical property, the test meter having a test region for accepting a test member, the test region being provided with an optical orientation sensor for measuring the at least one optical property of an orientation indicator region of a test member within the test meter, the optical orientation sensor generating an orientation signal indicative of the at least one optical property of the orientation indicator region, the test meter further comprising a processor for receiving said orientation signal and determining the orientation of the test member.

19. A test apparatus, comprising an elongate test strip and a test meter capable of determining the orientation of a stationary test strip fully inserted therein, the test strip comprising a first major surface and an opposing second major surface, each major surface having an orientation indicator region, the orientation indicator regions having a different reflectance, the test member further comprising a test portion for accepting a liquid sample, the reflectance of said test portion varying with a characteristic of said liquid sample, the test meter having a test region for accepting a test member, the test region being provided with an optical orientation sensor for measuring the reflectance of an orientation indicator region of a test member within the test meter and an optical test sensor for measuring the reflectance of the test portion of a test member within the test meter, the optical orientation sensor generating an orientation signal indicative of the reflectance of the orientation indicator region, the test sensor generating a signal indicative of the reflectance of the test portion, the test meter further comprising a processor for receiving said orientation signal and determining the orientation of the test member, said processor also receiving a signal from the test sensor and determining the characteristic of the liquid sample.
